(19) United States
(12) Patent Application Publication
(10) Pub. No.: US 2007/0176313 A1
(43) Pub. Date: Aug. 2, 2007

(54) Molding method and apparatus of fiber filler reinforced resin molded article

(75) Inventors: Junichi Ogawa, (US); Mitsuharu Kaneko, (US); Youhei Ichihara, (US); Takahiro Tochioka, (US)

Correspondence Address: NIXON PEABODY, LLP, 401 9TH STREET, NW, SUITE 900, WASHINGTON, DC, 20004-2128, US

(73) Assignee: MAZDA MOTOR CORPORATION

(21) Appl. No.: 11/635,492

(22) Filed: Dec. 8, 2006

(30) Foreign Application Priority Data
Feb. 2, 2006 (JP) 2006-026306

(51) Int. Cl. B29C 44/02

(52) U.S. Cl. 264/51; 425/4 C; 425/587

(57) ABSTRACT

In a molding method of a fiber filler reinforced resin molded article, in which a reinforcement fiber and a resin are plasticized and kneaded in a material supply cylinder including a screw with an anti counterflow portion, and the resin with the reinforcement fiber mixed therewith is injected into a cavity of a mold, the reinforcement fiber is mixed with the resin in the cylinder at a portion downstream of the anti counterflow portion of the screw, and a physical foaming agent is supplied into the cylinder at a portion downstream of the anti counterflow portion. Accordingly, there can be provided a molding method or apparatus of a fiber filler reinforced resin molded article that can improve properties by preventing the reinforcement fiber from being broken.

### BACKGROUND OF THE INVENTION

The present invention relates to a molding method and apparatus of a fiber filler reinforced foam resin molded article.

A resin molded article that is made from a foam resin material has been recently used widely for the purpose of weight reduction and the like. A molding method of such a foam resin molded article is generally known, in which a super critical fluid (SCF) as a physical foaming agent is previously supplied to a thermoplastic resin, and then the resin is injected into a cavity (a space in a mold) for foaming with a pressure reduction.

Herein, in order to purse further weight reduction, a resin molded article that is reinforced with a fiber such as a glass fiber to increase strength and rigidity has been also developed. In a molding method of such a fiber filler reinforced foam resin molded article, the resin containing the reinforcement fiber is plasticized and kneaded (molten) in a cylinder of an injection unit by using a screw (a process before injecting into the mold), so that the reinforcement fiber can be mixed well in the resin. Then, the super critical fluid is supplied to the molten resin with pressing to and maintaining a certain pressure, which is followed by injecting the resin into the cavity for foaming with the pressure reduction.

U.S. Patent Application Publication No. 2004/0253335 A1 discloses a molding method in which there is provided a gas supply nozzle for supplying the super critical fluid or a foaming agent to a portion just downstream of a ring-shaped check valve that is provided as a pressure-maintaining element at the injection molding screw. Herein, the ring-shaped check valve restricts a flow in an upstream direction, thereby maintaining a downstream pressure of a substance.

In a case where a fiber filler reinforced foam resin molded article is made with the conventional molding method disclosed in the above-described publication, there is a problem in that at a plasticizing stage by agitating and kneading the reinforcement fiber and resin, the reinforcement fiber is cut and broken by the screw, so the resin molded article may have poor properties that are worse than desired ones. In particular, when supplying the physical foaming agent, which is made of the super critical fluid or the like, into the cylinder for plasticizing, there is the following problem.

Namely, in case of using the super critical fluid as the foaming agent, the super critical fluid is supplied into the molten resin in a pressurized state to prevent foaming, the pressure is maintained in the process of injecting the molten resin into the mold, and the pressure is finally reduced (released) in the cavity. Accordingly, the pressure applied to the molten resin in the cylinder is maintained to a high pressure before the injection process. In the process of the spiral-shaped screw transmitting the molten resin to a downstream direction (injection end), the above-described pressure also acts on the upstream side of the supply portion of the super critical fluid, and therefore a force operative to push back the molten resin, resin pellets and reinforcement fiber would be generated. Accordingly, there may be a necessity that the screw has a certain mechanism to prevent the counterflow of the molten resin containing the super critical fluid at a portion that is located upstream of the supply portion of the super critical fluid.

This kind of anti counterflow mechanism generally comprises a labyrinth structure of resin flow path so as to prevent the upstream-direction pushing back. Herein, in case of applying the above-described structure of anti counterflow mechanism to the screw, there is a problem that the reinforcement fiber mixed with the resin would be cut into pieces and broken when getting though this mechanism (labyrinth structure). Thus, the properties of the fiber filler reinforced foam resin molded article that is made by the molding method with the super critical fluid would deteriorate improperly.

The above-described problem may not be recognized in the above publication because the resin containing the reinforcement fiber (short glass fiber) is supplied to a portion upstream of the ring-shaped check valve in its embodiment. The ring-shaped check valve changes its position in such a manner that its ring member contacts either one of a seal face and a block face of the screw, thereby allowing the resin to flow in the downstream direction and restricting the pressure from the super critical fluid supplied downstream. Accordingly, although this ring-shaped check valve may have the same problem of breakage of the reinforcement fiber, no countermeasure seems to be applied.

### SUMMARY OF THE INVENTION

The present invention has been devised in view of the above-described problem, and an object of the present invention is to provide a molding method and apparatus of a fiber filler reinforced resin molded article that can improve properties, such as strength, rigidity and the like, by preventing the reinforcement fiber from being broken at the anti counterflow portion of the screw.

According to the present invention, there is provided a molding method of a fiber filler reinforced resin molded article, in which a reinforcement fiber and a resin are plasticized and kneaded in a material supply cylinder including a screw with an anti counterflow portion, and the plasticized resin with the reinforcement fiber mixed therewith is injected into a cavity of a mold, wherein the reinforcement fiber is mixed with the resin in the cylinder at a portion downstream of the anti counterflow portion of the screw, and a physical foaming agent is supplied into the cylinder at a portion downstream of the anti counterflow portion of the screw.

Also, according to the present invention, there is provided a molding apparatus of a fiber filler reinforced resin molded article, in which a reinforcement fiber and a resin are plasticized and kneaded in a material supply cylinder including a screw with an anti counterflow portion, and the plasticized resin with the reinforcement fiber mixed therewith is injected into a cavity of a mold, the molding apparatus comprising a reinforcement-fiber mixing portion where the reinforcement fiber is mixed with the resin in the cylinder, the mixing portion being downstream of the anti counterflow portion of the screw, and a foaming-agent supply portion where a physical foaming agent is supplied into the cylinder, the supply portion being downstream of the anti counterflow portion of the screw.

According to the molding method or apparatus of the present invention, since the location of mixing the reinforcement fiber is downstream of the anti counterflow portion, the reinforcement fiber can be prevented from being broken at the anti counterflow portion. Also, the location of supplying the physical foaming agent is downstream of the anti counterflow portion. Herein, the reinforcement-fiber mixing portion and the foaming-agent supply portion may be located at the same location in the flow direction, or either one may be located upstream of the other. In any case, as long as both the portions are located upstream of the anti counterflow portion, the breakage of the reinforcement fiber can be prevented, without making the molding method or apparatus complex. Thus, the fiber filler reinforced resin molded article with improved properties, such as strength, rigidity and the like, can be provided.

According to an embodiment of the molding method or apparatus of the present invention, the physical foaming agent is a super critical fluid.

Thereby, since the super critical fluid can be mixed and dispersed uniformly as the physical foaming agent, the molded article having a properly fine foam cell can be provided.

According to another embodiment of the molding method or apparatus of the present invention, the reinforcement fiber is mixed with the resin in the cylinder at a portion that is located downstream of the above supply portion of the physical foaming agent.

Thereby, since the reinforcement fiber is mixed downstream of the supply portion of the physical foaming agent, the reinforcement fiber is mixed with the resin that has reduced its viscosity with the physical foaming agent, so that the mixing and dispersion of the reinforcement fiber can be improved.

According to further another embodiment of the molding method or apparatus of the present invention, the reinforcement fiber is provided independently so as to be mixed with the resin.

Thereby, since the reinforcement fiber is provided independently from the reinforcement-fiber mixing portion, a seal structure with proper airtightness can be applied at the reinforcement-fiber mixing portion. Accordingly, the physical foaming agent and the plasticized molten resin can be surely prevented from leaking out from the reinforcement-fiber mixing portion.

According to further another embodiment of the molding method or apparatus of the present invention, the reinforcement fiber is provided in a form of a continuous fiber to the cylinder, and the provided continuous fiber is cut into pieces by the screw, whereby the reinforcement fiber is mixed with the resin in the cylinder.

Thereby, since the reinforcement fiber is provided in the form of the continuous fiber, a proper airtightness at the reinforcement-fiber mixing portion can be improved properly with a simple structure, and the leakage of the physical foaming agent and plasticized molten resin from the reinforcement-fiber mixing portion can be surely prevented.

According to further another embodiment of the molding method of the present invention, mixing and dispersion of the reinforcement fiber in the resin is promoted in a resin flow path from the supply portion of the physical foaming agent to the cavity of the mold. And, according to further another embodiment of the molding apparatus of the present invention, there is provided a mixing-dispersion promoting device to promote mixing and dispersion of the reinforcement fiber in the resin in a resin flow path from the supply portion of the physical foaming agent to the cavity of the mold.

Thereby, even if the mixing and dispersion of the reinforcement fiber in the resin is insufficient, the promotion of mixing and dispersion of the reinforcement fiber in the path from the mixing portion of the reinforcement fiber to the cavity of the mold can be attained by the mixing-dispersion promoting device. Thus, the reinforcement fiber can be dispersed more uniformly in the plasticized molten resin, and the fiber filler reinforced resin molded article with excellent properties can be provided.

According to further another embodiment of the molding method or apparatus of the present invention, the resin with the physical foaming agent supplied thereto and the reinforcement fiber mixed therewith is collected temporarily, transmitted to an injection unit, metered for molding, and then supplied to the cavity of the mold via the injection unit.

Thereby, the molten resin with the physical foaming agent and reinforcement fiber, which is collected temporarily in the collection portion, is transmitted to the injection unit, and after metering of the resin for the necessary amount for molding, the resin is supplied into the cavity of the mold via the injection unit. Thus, since this supply (confluence) promotes the mixing and dispersion of the reinforcement fiber in the molten resin, the reinforcement fiber can be dispersed uniformly, and the fiber filler reinforced resin molded article with more excellent properties can be provided.

According to further another embodiment of the molding apparatus of the present invention, there is provided a seal device to seal an inside from an outside of the cylinder at the reinforcement-fiber mixing portion.

Thereby, since the reinforcement-fiber mixing portion is sealed by the seal device, the leakage of the physical foaming agent and plasticized molten resin from the reinforcement-fiber mixing portion can be surely prevented.

According to further another embodiment of the molding apparatus of the present invention, there is provided a flow-amount detecting device that is provided in a leakage path of the physical foaming agent leaking from the reinforcement-fiber mixing portion and detects an amount of leakage of the physical foaming agent, and the physical foaming agent is configured to be supplemented from the foaming-agent supply portion according to the leakage amount thereof detected by the flow-amount detecting device.

Thereby, the amount of leakage of the physical foaming agent is detected by the flow-amount detecting device provided in the leakage path of the physical foaming agent leaking from the reinforcement-fiber mixing portion, and the amount of the physical foaming agent corresponding to the amount that has leaked is supplemented from the foaming-agent supply portion. Thus, the necessary amount of the physical foaming agent in the resin composite can be maintained, and thereby the properties of the resin molded article having a desirable foaming ratio can be improved.

Other features, aspects, and advantages of the present invention will become apparent from the following description which refers to the accompanying drawings.

### BRIEF DESCRIPTION OF THE DRAWINGS

FIG. 1A is a side view showing an entire structure of a fiber filler reinforced resin injection molding apparatus according to a first embodiment of the present invention, FIG. 1B is a sectional view showing a cylinder inside of a plasticizing pushing portion, and FIG. 1C is a sectional view showing a structure of a major portion of the cylinder inside of the plasticizing pushing portion.

FIG. 2 is a partially sectional view showing a GF supply unit with a seal structure that prevents a leakage of a foaming agent at the GF supply portion in the first embodiment.

FIG. 3 is a side view showing an entire structure of a fiber filler reinforced resin injection molding apparatus according to a second embodiment.

FIG. 4 is an explanatory diagram showing a schematic structure of a device to compensate a leakage of a physical foaming agent at a GF supply portion of a filler reinforced resin injection molding apparatus according to a third embodiment.

FIG. 5A a view showing an attachment state of a mixing nozzle, and FIG. 5B is a sectional view of a major portion of the mixing nozzle.

FIG. 6A is a sectional view showing a cylinder inside of a metering injecting portion with a supersonic oscillator (or an electromagnetic-wave oscillator) of a vibration adding device, and FIG. 6B is a sectional view showing an attachment state of an agitating plate in the cylinder inside of the metering injecting portion.

FIG. 7 is a sectional view of a mold in which the mixing nozzle and a similar agitating device are provided at a hot runner portion.

FIG. 8 is a side view of a foaming-agent supply portion in which a porous member is disposed at an inside wall of a supply nozzle.

FIG. 9 is a side view showing a seal structure with a resilient member as a modified embodiment.

### DETAILED DESCRIPTION OF THE INVENTION

Hereinafter, a molding method and apparatus of a fiber filler reinforced resin molded article of the present invention will be described specifically.

### Embodiment 1

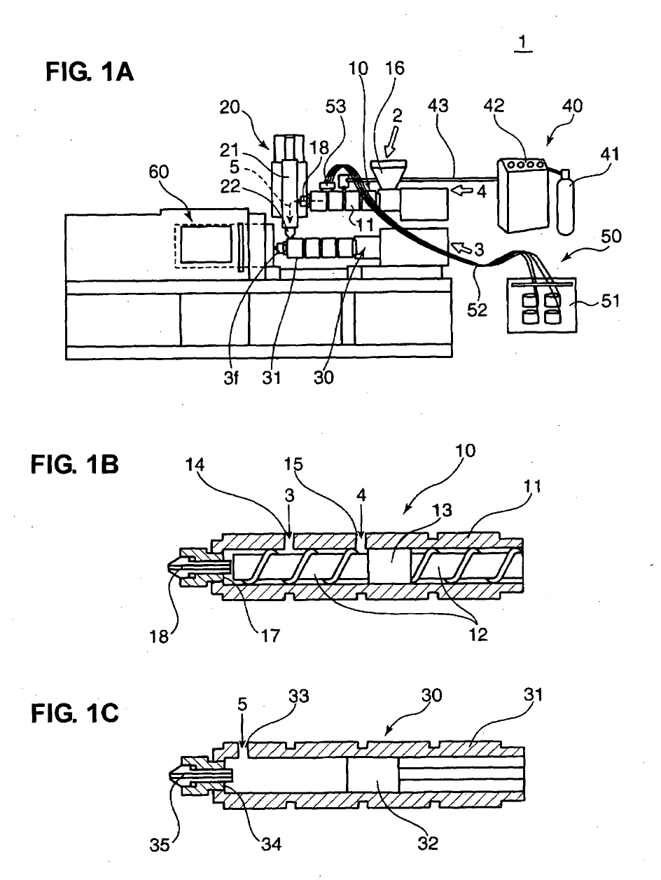

An entire structure of a fiber filler reinforced resin injection molding apparatus according to a first embodiment of the present invention is shown in FIG. 1. The fiber filler reinforced resin injection molding apparatus 1 comprises a plasticizing pushing portion 10, a resin collection portion 20, a metering injecting portion 30, a SCF supply unit 40, a GF supply unit 50, and a mold 60.

The plasticizing pushing portion 10 has a screw 12 in a material supply cylinder 11, and agitates and kneads a resin 2 which is provided from a hopper 16 with a rotation of the screw 12 for plasticizing (melting). And, a reinforcement fiber 3, which is supplied from the GF supply unit 50 at a reinforcement-fiber mixing portion 14, and a physical foaming agent 4, which is supplied from the SCF supply unit 40 at a foaming-agent supply portion 15, are mixed with the plasticized molten resin. Then, the plasticized molten resin containing the reinforcement fiber 3 (and the physical foaming agent 4) (hereinafter, referred to as resin composite 5) is pushed out (transmitted) to a resin collection portion 20, where the resin is collected temporarily in a collector 21. In the present embodiment, the plasticizing pushing portion 10 is not constituted as an injection unit, and has a capability to push out and transmit the plasticized resin composite 5 to the resin collection portion 30. An on-off valve 18 is provided at a pushing end (outlet) 17 of the plasticizing pushing portion 10.

The screw 12 provided inside the cylinder 11 includes an anti counterflow portion 13. The anti counterflow portion 13 may be configured, for example, to have a labyrinthine structure as described above, or a ring-member position changing mechanism. Position relationships among the counterflow portion 13, the reinforcement-fiber mixing portion 14, and the foaming-agent supply portion 15 will be described specifically below.

The resin collection portion 20 collects the resin composite 5 transmitted from the plasticizing pushing portion 10 in the collector 21 temporarily. The resin composite 5 in the collector 21 is controlled so as to be transmitted to a junction portion 33 of the metering injecting portion 30 by a valve 22 that is provided at a downward end (outlet) of the collector 21.

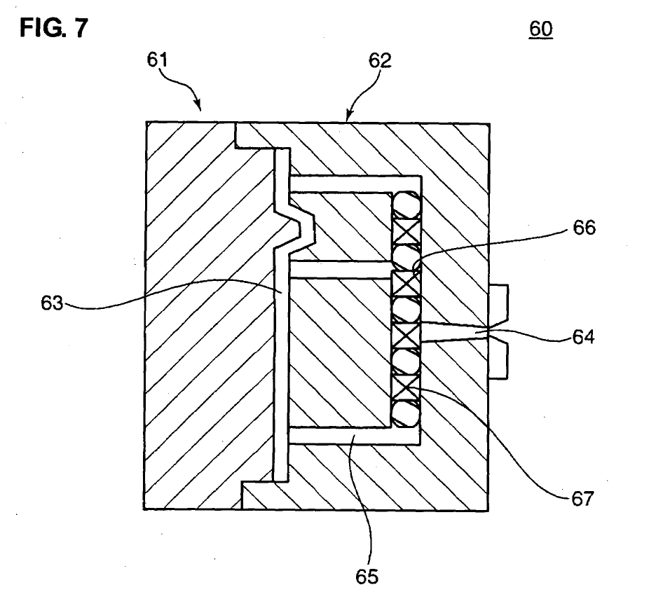

The metering injecting portion 30 is configured to be an injection unit in which an injection piston 32 is provided in the cylinder 31, and guides the resin composite 5 in the collector 21 to the junction portion 33 so as to make the reinforcement fiber 3 and the physical foaming agent 4 be mixed with the resin composite 5. Further, after metering of the resin composite for a necessary amount for molding, the resin composite 5 is configured to be injected into a cavity 63 (see FIG. 7) of the mold 60 with an opening/closing operation of a valve 35 that is provided at an injecting end 34 (outlet) and an reciprocating movement of the injection piston 32.

As described above, at the lower ends (outlets) of the plasticizing pushing portion 10, resin collection portion 20, and metering injecting portion 30 are provided the valves 18, 22 and 35 that are opened or closed with the on-off operation. These valves 18, 22 and 35 allow the resin composite 5 to flow out when opening, and when closing, they stop the flow and prevent counterflow of the resin composite 5 as well, ensuring a proper seal function. Herein, since these valves are just operated to open and close, the reinforcement fiber 3 may not be broken or hurt by operations of the valves.

The SCF supply unit 40 guides the physical foaming agent 4 into the fiber filler reinforced resin injection molding apparatus 1, in which the foaming agent 4 is supplied into the cylinder 11 (the resin 2) at the foaming-agent supply portion 15 provided at the plasticizing pushing portion 10. The SCF supply unit 40 comprises a gas reservoir 41 with a raw gas stored therein, and a pressure-increase control portion 42 to increase a pressure of the raw gas from the gas reservoir 41 to a specified pressure and control a supply amount of the pressure-increased physical foaming agent into the cylinder 11.

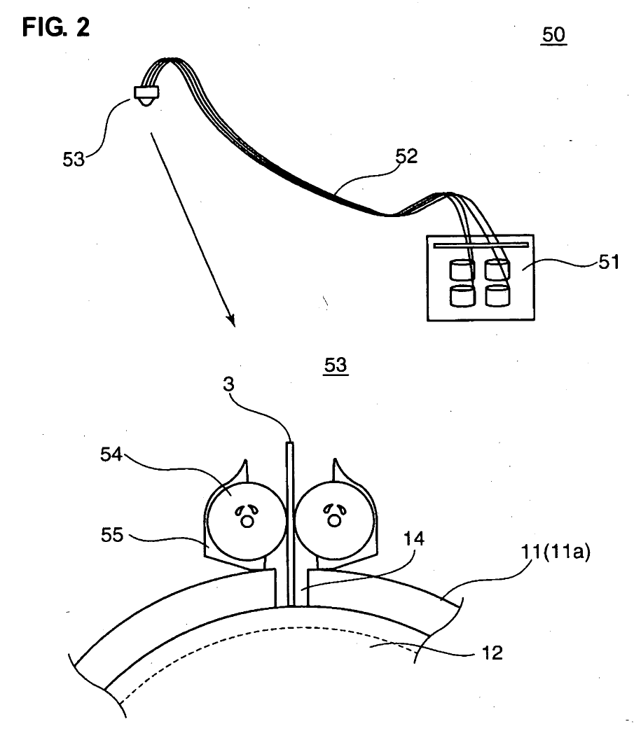

The GF supply unit 50 supplies the reinforcement fiber 3 (continuous glass fiber 3 in the present embodiment) to the reinforcement-fiber mixing portion 14 of the plasticizing pushing portion 10. The GF supply unit 50 comprises, as shown in FIG. 2, a GF storage portion 51 that stores the round glass fiber 3 in a coil shape therein with a proper seal, a GF supply portion 53 that is connected to the reinforcement-fiber mixing portion 15, a flexible supply pipe 52 that interconnects the GF storage portion 51 and the GF supply portion 53 and supplies the glass fiber 3 therein. The GF supply portion 53 of the present embodiment comprises a fiber supply roller 54 to supply the glass fiber 3 with its rotation, and a seal member 55 that can provide proper sealing between side walls of the cylinder 11 (cylinder barrel 11a), in which the roller 54 is held by the seal member 55 so as to be pushed against a periphery of an opening of the reinforcement-fiber mixing portion 14. Accordingly, the portions 51, 52 and 53 are connected with proper sealing (airtightness), and the inside circumference is properly shut off from an outside atmosphere with the sealing. Thereby, the physical foaming agent 4 and the resin composite 5 containing the foaming agent 4, which have been supplied into the cylinder 11, are prevented from leaking out from the reinforcement-fiber mixing portion 14 (GF supply portion 53, GF supply unit 50).

Then, the continuous glass fiber 3 is supplied into the cylinder 11 of the plasticizing pushing portion 10 by the roller 54 with its rotation, where the fiber 3 is cut into pieces by a shearing force of the screw 12 rotating in the cylinder 11. A length of the fiber pieces can be adjusted by the rotational speed of the screw 12 and the supply speed of the fiber 3 by the roller 54.

According to the present embodiment, the mixing portion 14 of the reinforcement fiber 3 is located downstream of the anti counterflow portion 13 of the screw. Also, the supply portion 15 of the physical foaming agent 4 is likewise located downstream of the anti counterflow portion 13 of the screw and upstream of the mixing portion 14 of the reinforcement fiber 3. Thus, by the location of the mixing portion 14 of the reinforcement fiber 3 downstream of the anti counterflow portion 13, the reinforcement fiber 3 can be prevented from being broken at the anti counterflow portion 13. And, by the location of the supply portion 15 of the physical foaming agent 4 upstream the mixing portion 14 of the reinforcement fiber 3, the reinforcement fiber 3 is mixed with resin 2 that has reduced its viscosity with the physical foaming agent 4, so that the mixing and dispersion of the reinforcement fiber 3 can be improved. Also, the mixed fiber 3 is transmitted downward by the physical foaming agent 4, so it may not go upstream.

Further, according to the present embodiment, the reinforcement fiber 3 is mixed with the resin 2 at the portion (mixing portion 14) located downstream of the supply portion of the physical foaming agent 4 (supply portion 15). Accordingly, the reinforcement fiber 3 is mixed with resin 2 that has reduced its viscosity with the physical foaming agent 4, so that the mixing and dispersion of the reinforcement fiber 3 in the resin composite 5 can be improved.

In the present embodiment, a thermoplastic resin is used as the following resin 2, and the following thermoplastic resin may be applied; polyethylene-based resin, polypropylene-based resin, acrylonitrile-butadiene-styrene copolymer (ABS resin), polystyrene-based resin, polycarbonate-based resin, polyethylene terephthalate, polybutylene terephthalate, acrylonitrile-styrene copolymer (AS resin), sybdiotactic polystyrene, polymethyl methacrylate, polyphenylene sulfide, polyether sulfone, polyarylate, polyamide, polyimide, liquid crystal resin, polyphenylene oxide, polyacetal, polyethylene naphthalate, and so on. Especially, the polypropylene-based resin, polystyrene-based resin, polycarbonate-based resin, sybdiotactic polystyrene, polyphenylene sulfide are preferable, and polypropylene-based resin are more preferable. Also, polymer blend is applicable as the thermoplastic resin.

Also, as the reinforcement fiber 3, glass fiber, carbon fiber, inorganic whisker, potassium titanate whisker, and so on may be applied.

The content of the thermoplastic resin 2 with respect to the thermoplastic resin composite 5 is preferably 20-95 wt %, more preferably 60-90 wt %. There is a concern of a poor flowing function or a weak mechanical rigidity if the content of the thermoplastic resin 2 is too small. Also, the content of the reinforcement fiber 3 with respect to the thermoplastic resin composite 5 is preferably 0-50 wt %, more preferably 10-40 wt %.

Further, to the above-described thermoplastic resin composite 5 may be added an additive or changing agent, such as powder fillers, plasticizing agent, stabilizing agent, anti oxidant, ultraviolet-ray absorbent, anti-charging agent, flame retardant, or flame-resistant agent.

The physical foaming agent 4 in the present embodiment includes any foaming agent with a pressure lower than the super critical pressure, other than the super critical fluid in the super critical state (Super Critical Fluid: SCF), just excluding a chemical foaming agent that foams with a heat caused by a chemical reaction. Although any type of physical foaming agent 4 may be applied in the present embodiment as long as it can be molten in the thermoplastic resin composite 5 and is an inert gas regardless of being in the super critical state, the super critical fluid of carbon dioxide, nitrogen or composite gas of these is preferable from viewpoints of safety, costs and the like. And, when the physical foaming agent 4 of these gas is applied, the foaming agent 4 can be mixed and dispersed well, thereby providing the fiber filler reinforced resin molded article (product) having a properly fine foam cell and a further improved properties.

The application of the super critical fluid of carbon dioxide may be more preferable because of little damage against the global environment. The critical temperature of the carbon dioxide is 31.3° C. and the critical pressure thereof is 7.4 MPa, and the critical temperature of the nitrogen is −147° C. and the critical pressure thereof is 3.4 MPa. Accordingly, the super critical state of these can be easily maintained by heating and pressuring (herein, heating may not be necessary for the nitrogen). Also, since the super critical fluid of the carbon dioxide or nitrogen functions as a plasticizing agent, the flowing of the resin can be improved, thereby providing the injection molding of the resin composite 5 containing the reinforcement fiber 3 with better flowing properties.

It is preferable from viewpoints of ensuring a sufficient supply speed that the pressure at a time the physical foaming agent 4 is supplied to the thermoplastic resin composite 5 be set to 15 MPa or more, further preferably 20 MPa or more. The supply amount of the physical foaming agent 4 depends on the kind thereof, but it is preferable that the supply amount with respect to 100 wt % of the thermoplastic resin composite 5 be set to 0.1-20 wt %, further preferably 0.5-10 wt %. When the physical foaming agent 4 is less than 0.1 wt %, the properly fine foam cell can not be provided. Meanwhile, when the physical foaming agent 4 is greater than 20 wt %, the foam cell may become too large and an appearance of the molded article may deteriorate.

In the present embodiment, the mold 60 comprises a stationary mold 61 and a movable mold 62, which are made from metal material such as carbon steel, aluminum alloy, or copper alloy. The cavity 63 is formed by these molds 61, 62 coupled to each other, and a hot runner portion 66 is provided in a flow path of the molten resin composite 5 from an injection supply hole 64 (nozzle) to a gate 65.

As described above, according to the present embodiment, since the location of mixing the reinforcement fiber 3 (reinforcement-fiber mixing portion 14) is downstream of the anti counterflow portion 13, the reinforcement fiber 3 can be prevented from being broken at the anti counterflow portion 13. Also, the location of supplying the physical foaming agent 4 (foaming-agent supply portion 15) is downstream of the anti counterflow portion 13. Herein, the reinforcement-fiber mixing portion 14 and the foaming-agent supply portion 15 may be located at the same location in the flow direction, or either one may be located upstream of the other. In any case, as long as both the portions 14, 15 are located upstream of the anti counterflow portion 13, the breakage of the reinforcement fiber 3 can be prevented, without making the molding method or apparatus complex. Thus, the fiber filler reinforced resin molded article with improved properties, such as strength, rigidity and the like, can be provided.

According to the present embodiment, the reinforcement-fiber mixing portion 14 is located downstream of the foaming-agent supply portion 15. Thereby, since the reinforcement fiber 3 is mixed with the resin 2 to which the physical foaming agent 4 is supplied, the reinforcement fiber 3 is mixed with resin 2 that has reduced its viscosity with the physical foaming agent 4. Thus, the mixing and dispersion of the reinforcement fiber 3 in the resin composite 5 can be improved.

Further, since the reinforcement fiber 3 is provided independently from the reinforcement-fiber mixing portion 14, the seal structure with proper airtightness can be applied at the reinforcement-fiber mixing portion 14. Thereby, the physical foaming agent 4 and the resin composite 5 can be surely prevented from leaking out from the reinforcement-fiber mixing portion 14. Also, since the reinforcement fiber 3 is provided in the form of the continuous fiber, the proper airtightness can be improved properly with a simple structure.

The resin composite 5 collected temporarily in the resin collection portion 20 is transmitted to the metering injecting portion 30, and after metering of the resin composite 5 for the necessary amount for molding, the resin composite 5 is supplied into the cavity 63 of the mold 60 via the metering injecting portion 30. Since this supply (confluence) promotes the mixing and dispersion of the reinforcement fiber 3 in the resin composite 5, the reinforcement fiber 3 can be dispersed uniformly. Thus, the fiber filler reinforced resin molded article with more excellent properties can be provided.

### Embodiment 2

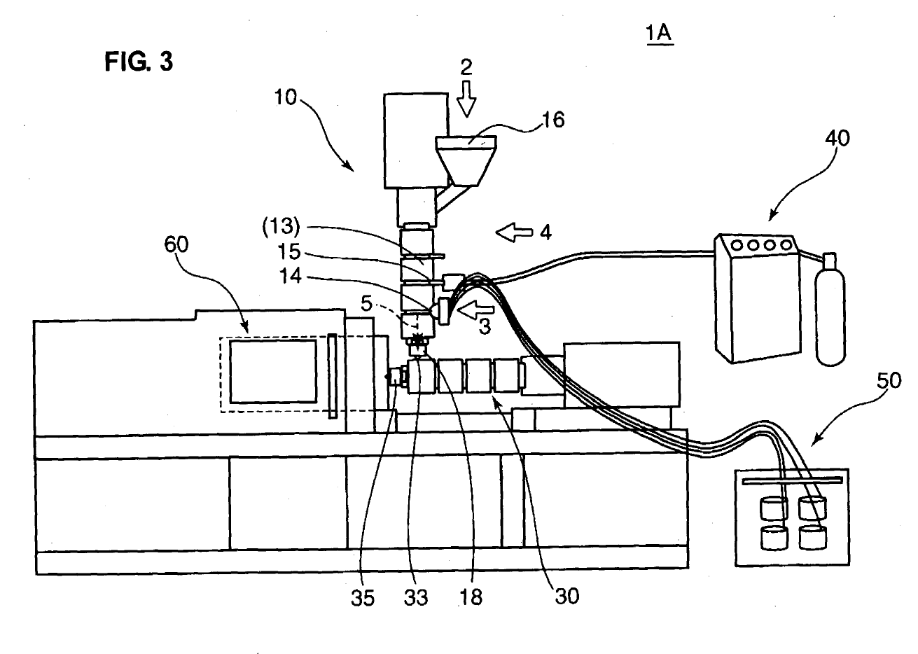

An entire structure of a fiber filler reinforced resin injection molding apparatus according to a second embodiment of the present invention is shown in FIG. 3. The fiber filler reinforced resin injection molding apparatus 1A is different from the apparatus 1 of the first embodiment in having no resin collection portion 20. The apparatus 1A has the same components as the apparatus 1 except this portion. The same components of the apparatus 1A are denoted by the same reference characters as those of the apparatus 1, whose descriptions will be omitted.

In the present embodiment, the resin composite 5 plasticized at the plasticizing pushing portion 10 is supplied directly to the junction portion 33 of the metering injecting portion 30. At the junction portion 33, the mixing and dispersion of the reinforcement fiber 3 and the physical foaming agent 4 in the resin composite 5 is attained, and after metering of the resin composite 5 for the necessary amount for molding, the resin composite 5 is injected into the cavity 63 of the mold 60.

In the second embodiment, like the first embodiment, the foaming-agent supply portion 15 is located downstream of the anti counterflow portion 13, and the reinforcement-fiber mixing portion 14 is located downstream of the foaming-agent supply portion 15. Accordingly, the reinforcement fiber 3 can be prevented from being broken at the anti counterflow portion 13, and the reinforcement fiber 3 can be mixed and dispersed properly in the resin composite 5. Thus, the fiber filler reinforced resin molded article with the improved properties, such as strength, rigidity and the like, can be provided.

### Embodiment 3

In the above-described first embodiment, the seal member 55 is provided at the GF supply portion 53 to prevent the physical foaming agent 4 and the resin composite 5 from leaking out of the reinforcement-fiber mixing portion 14 (GF supply unit 50). There may be provided a compensating means for compensating the physical foaming agent 4 according to the amount of leakage of the agent 4 instead.

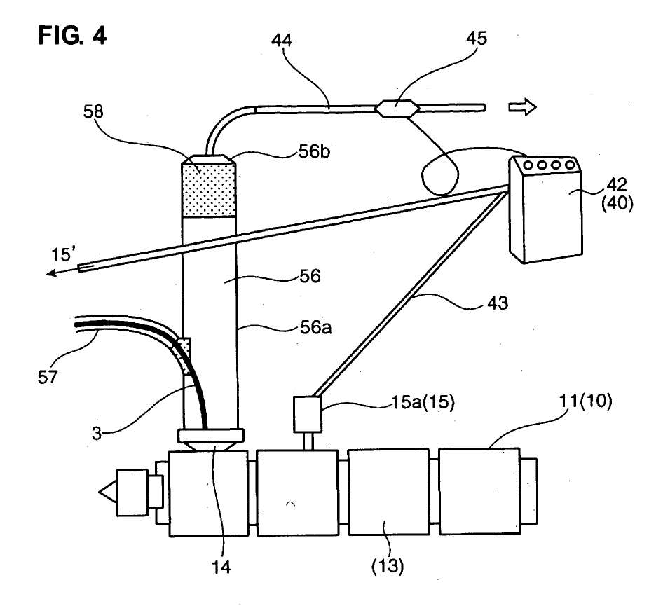

A schematic structure of a plasticizing pushing portion equipped with a leakage compensating device of the physical foaming agent is shown in FIG. 4. This plasticizing pushing portion 10, which is applied to the injection molding apparatus 1, 1A of the first and second embodiments, includes the foaming-agent supply potion 15 located downstream of the anti counterflow portion 13 and the reinforcement-fiber mixing portion 14 located downstream of the foaming-agent supply potion 15. To the foaming-agent supply potion 15 is coupled a supply pipe 43 to supply the physical foaming agent 5 from the SCF supply unit 40. To the reinforcement-fiber mixing portion 14 is coupled a buffer tank 56, and a branch pipe 57 (provided near the supply pipe 52) to supply the reinforcement fiber 3 from the GF supply unit 50 is attached to a cylindrical side wall face 56a of the buffer tank 56. To an upper end wall face 56b of the buffer tank 56 is connected a SCF guide pipe 44 to guide the physical foaming agent 4 that has leaked to an outside environment or the SCF supply unit 40. And, a flow meter 45 (flow-amount detecting device) is disposed in the SCF guide pipe 44. The flow meter 45 detects the leakage amount of the physical foaming agent 4. Information of this leakage amount is fed back to the SCF supply unit 40, which operates to supply the same amount of the physical foaming agent 4 as the leakage amount into the cylinder 11 through the foaming-agent supply portion 15. Instead, a second foaming-agent supply portion 15′ (not illustrated) may be provided downstream of the reinforcement-fiber mixing portion 14, and the same leakage amount of the physical foaming agent 4 may be supplied again from the SCF supply unit 40 into the cylinder 11 via this second foaming-agent supply portion 15′.

Thus, the amount of the physical foaming agent 4 that corresponds to the amount that has leaked can be supplemented from the foaming-agent supply portion 15, 15′. The necessary amount of the physical foaming agent 4 in the resin composite 5 can be maintained, and thereby the properties of the resin molded article having a desirable foaming ratio can be improved. Herein, the above-described necessary amount and the desirable foaming ratio should be properly decided in designing the resin molded article. Herein, a porous member 58 is provided at an inside face of the upper end wall face 56b and an inside face of the attaching portion of the branch pipe 57 of the buffer tank 56. This porous member 58 shuts the flow of the resin composite 5 with the physical foaming agent 4, thereby preventing the resin composite 5 from leaking further.

According to the third embodiment, the leakage amount of the physical foaming agent 4 that has leaked from the reinforcement-fiber mixing portion 14 is detected by the flow-amount detecting device (flow meter 45) in the path (SCF guide pipe 44), and the physical foaming agent 4 can be supplemented by the amount corresponding to the leakage amount from the foaming-agent supply portion 15, 15′. Thereby, the necessary amount of the physical foaming agent 4 in the resin composite 5 can be maintained, and the properties of the resin molded article having the desirable foaming ratio can be improved.

The above-described embodiments are just examples, and the present invention should not be limited to these. Any modifications can be applied within the scope of a sprit of the present invention.

Hereinafter, some modifications of the above-described embodiments will be described.

1) Although the supply portion 15 of the physical foaming agent 4 and the mixing portion 14 of the reinforcement fiber 3 are located downstream of the anti counterflow portion 13 of the screw 12 in this order in the first, second and third embodiments, the supply portion 14 of the reinforcement fiber 3 may be located upstream of the supply portion 15 of the physical foaming agent 4, or these portions 14, 15 are located at the same location in the flow direction as long as these portions 14, 15 are located downstream of the anti counterflow portion 13.

2) Although the reinforcement fiber 3 in the form of the continuous fiber is supplied from the GF supply unit 50 and independently mixed with the resin in the cylinder 11 at the mixing portion 14 in the first, second and third embodiments, the resin 2 containing the reinforcement fiber 3 with a previously-cut specified length may be supplied from a reinforcement-fiber/resin supply portion that is located downstream of the anti counterflow portion 13. Herein, since there is a concern of leakage of the physical foaming agent 4 and resin composite 5 due to the pressure increasing according to the supply of the physical foaming agent 4 at the reinforcement-fiber/resin supply portion, it may be necessary to provide the seal structure described above. Herein, in the case where the fiber in the form of the continuous fiber is supplied like the above embodiment, the seal structure at the mixing portion 14 of the reinforcement fiber 3 can be formed easily. Accordingly, the above-described structure may be preferable.

3) In the first, second and third embodiments, the reinforcement fiber 3 supplied from the mixing portion 14 of the plasticizing pushing portion 10 is mixed with the resin composite 5 along with the physical foaming agent 4 in the area from the portion 14 to the valve 18 at the pushing end (outlet) 17, and the plasticized resin composite 5 is received from the resin collection portion 20 or the plasticizing pushing portion 10 at around the injecting end 34 (outlet) of the metering injecting portion 30, and the mixing and dispersion of the reinforcement fiber 3 and the physical foaming agent 4 in the resin composite 5 is attained using mixing/dispersion effects by flowing. Herein, however, there is a concern of an insufficiency in this mixing and dispersion. Namely, a distance between the reinforcement-fiber mixing portion 14 and the valve 18 at the pushing end (outlet) 17 is relatively short because of the location of the mixing portion 14 downstream of the anti counterflow portion 13, and thereby the mixing and dispersion of the reinforcement fiber 3 and the foaming agent 4 with the resin composite 5 might become insufficient.

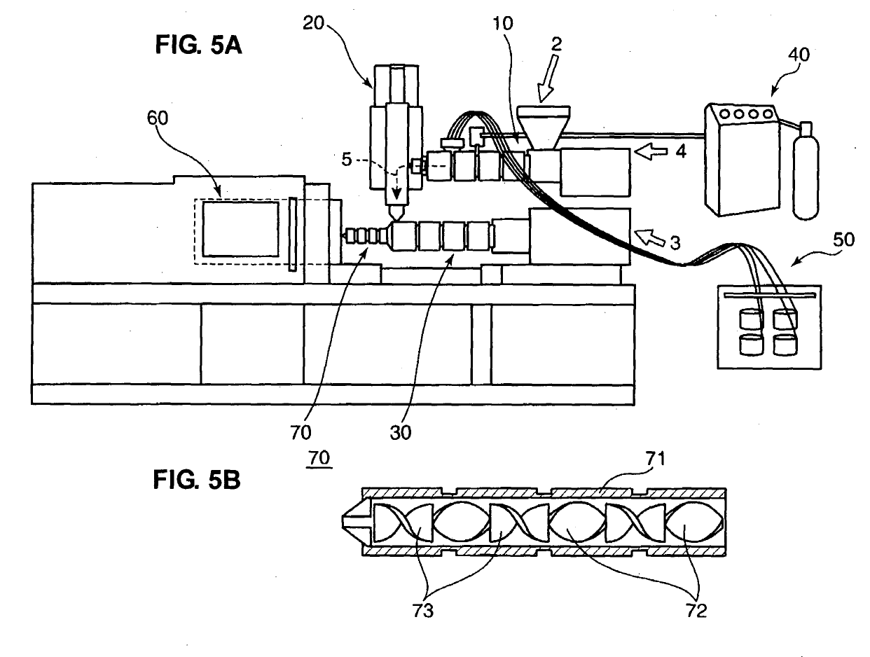

Accordingly, it is preferable, as shown in FIG. 5A, that the resin composite 5 be injected into the mold 60 from the metering injecting portion 30 via a mixing nozzle 70 in the above-described embodiments. This mixing nozzle 70 is configured such that elements A72 that are made of flat plates respectively by twisting clockwise by 180 degrees spirally and other elements B73 that are made of flat plates respectively by twisting counterclockwise by 180 degrees spirally are disposed one after the other in an axis direction. Thus, the resin composite 5 is twisted clockwise and counterclockwise repeatedly when proceeding in the mixing nozzle 70. Thereby, the mixing and dispersion of the reinforcement fiber 3 and the physical foaming agent 4 can be promoted.

Accordingly, even if the mixing and dispersion of the reinforcement fiber 3 in the resin composite 5 is insufficient (or there is such a concern), the promotion of mixing and dispersion of the reinforcement fiber 3 in the path from the mixing location (mixing portion 14) of the reinforcement fiber 3 to the cavity 63 of the mold 60 can be attained by the mixing-dispersion promoting device like the mixing nozzle 70. Thus, the reinforcement fiber 3 can be dispersed more uniformly in the resin composite 5, and the fiber filler reinforced resin molded article with excellent properties can be provided.

Herein, the mixing-dispersion promoting device is not limited to the above-described mixing nozzle 70. The internal structure of the mixing nozzle 70 is not limited to the above one, but any modifications may be applied as long as the resin composite 5 can be agitated well in the resin flowing path and thereby the mixing and dispersion of the reinforcement fiber 3 and physical foaming agent 4 can be promoted. As modifications of the mixing nozzle 70, the following alternatives shown in 4)-6) may be applied.

4) Although the mixing and dispersion of the reinforcement fiber 3 and the physical foaming agent 4 in the resin composite 5 is attained when these are received at the metering injecting portion 30 in the first, second and third embodiments, there is not provided any particular promoting mechanism to promote the mixing and dispersion. Herein, there may be provided a vibration adding device for promoting the mixing and dispersion of the reinforcement fiber 3 and physical foaming agent 4 by actively adding vibrations to the resin composite 5.

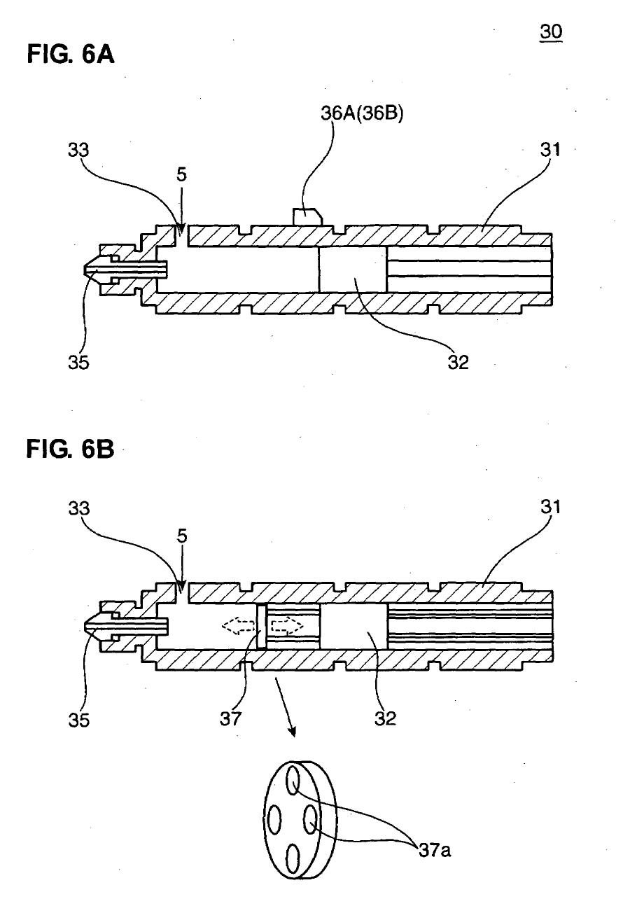

For example, a mechanical-vibration adding device with a supersonic oscillator 36A (vibrator device) or a heating-vibration adding device with an electromagnetic-wave vibrator 36B may be applied as the vibration adding device. In case of using a supersonic vibration, as shown in FIG. 6A, the supersonic oscillator 36A is attached to the side wall of the cylinder 31 (cylinder barrel outer face) of the metering injecting portion 30. The supersonic oscillator 36A vibrates by receiving a supersonic voltage from a supersonic vibrator, not illustrated, so the vibration (agitating force) can be added to the resin composite 5 in the cylinder 31. An attaching portion of the supersonic oscillator 36A is not limited to the above portion. In case of using the electromagnetic-wave vibration adding device, an attachment of the electromagnetic-wave vibrator 36B is the same as above.

Thus, the vibration is added to the resin composite 5 with the device such as the supersonic oscillator 36A and electromagnetic-wave vibrator 36B, so the mixing and dispersion of the reinforcement fiber 3 and physical foaming agent 4 in the resin composite 5 can be promoted.

A type of device that can add a flowing force to the resin and thereby agitate it may be applied as the vibration adding device as well. As shown in FIG. 6B, an agitating plate 37 having plural through holes 37a is disposed in a space that is located on a side of the junction portion 33 before the injection piston 32 in the cylinder 31 of the metering injecting portion 30. This agitating plate 37 is operated so as to move back and force (reciprocate) in a state where the location of the injection piston 32 is fixed. Thereby, the resin composite 5 is made get through these holes 37a according to the back-and-forth movement of the agitating plate 37 (generating a turbulence), so the mixing and dispersion of the reinforcement fiber 3 and physical foaming agent 4 in the resin composite 5 can be promoted. When the injection is conducted, both the injection piston 32 and the agitating plate 37 are moved forward to inject the resin composite 5 into the mold 60.

Herein, when the injection is conducted, the agitating plate 37 is moved forward along with the injection piston 32 in a state where it is fixed to the piston 32, or previously moved forward before the piston 32 is moved forward, so that the agitating plate 37 can be prevented from interfering with the movement of the injection piston 32 at the injection process. The shape or the number of the through holes 37a of the agitating plate 36 should not be limited to an illustrated circular shape or four. Also, something like the above-described elements 72, 73 (180-degree clockwise and counterclockwise twisted plates) applied to the mixing nozzle 70 may be provided at the holes 37a, or the holes 37a may be formed to be of a spiral shape like these elements 72, 73. Thereby, the effect of the promotion of mixing and dispersion by the agitating plate 37 can be enhanced.

Further, any type of agitating device other than the above-described plate 37, which can add the flowing force to the resin composite 5 with a reciprocating drive or a rotating drive and thereby agitate it, may be applied. For example, a propeller type of member with agitating wings may be rotated, or a plate member with circular holes having agitating wings therein may be reciprocated.

5) Although there is not provided a particular mechanism to promote the mixing and dispersion of the reinforcement fiber 3 and physical foaming agent 4 at the mold 60 in the first, second and third embodiments, a mixing portion 67 that has a kneading and agitating function with the same structure as the above-described mixing nozzle 70 may be provided in the flow path (e.g., hot runner 66) of the molten resin composite 5 in the mold 60 as shown in FIG. 7. Thereby, the mixing and dispersion of the reinforcement fiber 3 and physical foaming agent 4 can be promoted before the resin composite 5 flows into the cavity 63 of the mold 60.

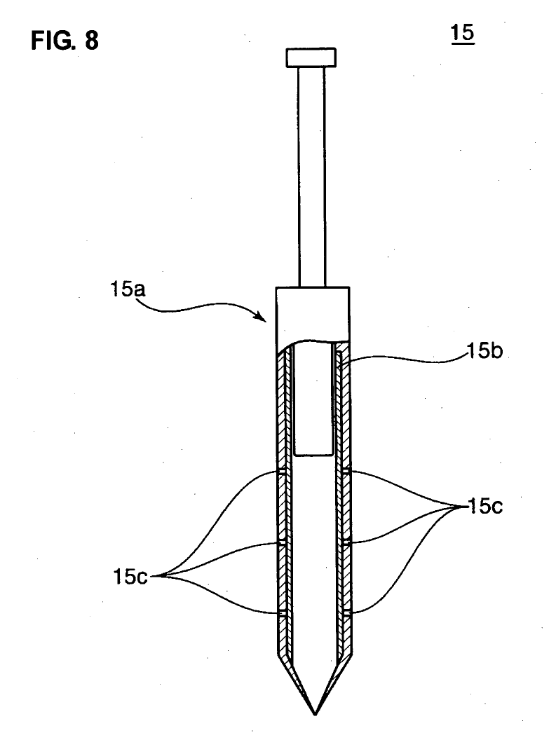

6) Although there is not provided a particular mechanism to promote the mixing and dispersion of the physical foaming agent 4 at the foaming-agent supply portion 15 of the plasticizing pushing portion 10 in the first, second and third embodiments, a porous structure 15b (e.g., a metal porous member) may be disposed at an inner wall face of the injection nozzle 15a as shown in FIG. 8. Thereby, the physical foaming agent 4 supplied from supply holes 15c is introduced into the resin composite 5 with an increased contacting face, so a prompt dispersion of the physical foaming agent 4 into the resin composite can be attained, thereby promoting the mixing and dispersion.

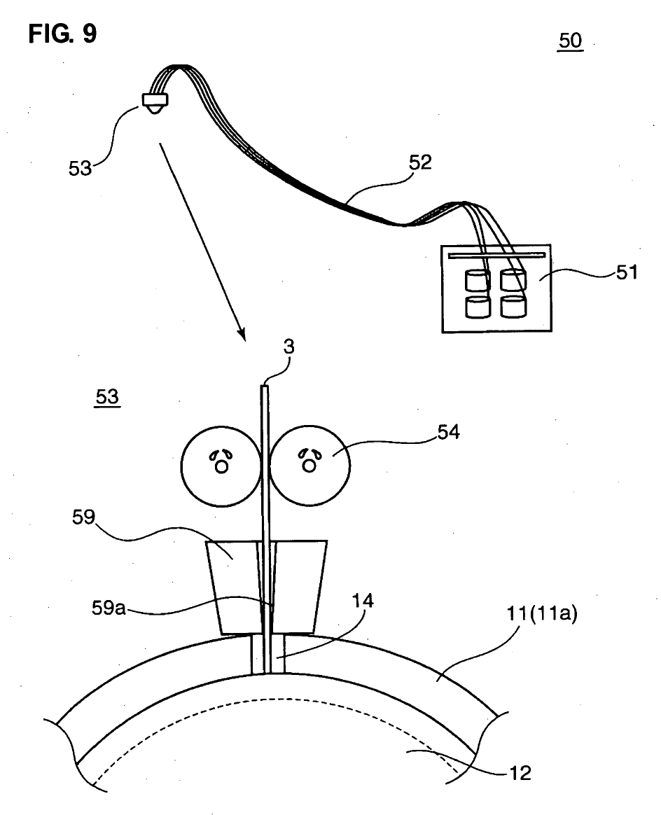

7) Although there is provided the seal structure for sealing an entire part of the GF supply unit 50 in which the seal member 55 holding the fiber-supply roller 54 is pushed against the cylinder barrel 11a (around the opening of the reinforcement-fiber supply portion 14) in the first embodiment, a resilient member 59 with a rubber resiliency may be applied for sealing. For example, as shown in FIG. 9, a cork-shaped rubber member 59 with a center through hole 59a (with its minimum inner diameter smaller than the diameter of the glass fiber 3) is pushed against the cylinder barrel 11a, in which the reinforcement fiber 3 is supplied through the center hole 59a, so the seal structure with proper airtightness can be provided. Herein, a pushing face of the resilient member 59 against the cylinder barrel 11a is not limited to a flat one that is illustrated in this figure, but it may have a projection in an O-ring shape. Thus, the seal structure (resilient member 59) is applied locally at the GF supply portion 53 (reinforcement-fiber mixing portion 14), which may provide the simple seal structure and reduce manufacturing costs properly.

What is claimed is:

1. A molding method of a fiber filler reinforced resin molded article, in which a reinforcement fiber and a resin are plasticized and kneaded in a material supply cylinder including a screw with an anti counterflow portion, and the plasticized resin with the reinforcement fiber mixed therewith is injected into a cavity of a mold,
wherein the reinforcement fiber is mixed with the resin in the cylinder at a portion downstream of the anti counterflow portion of the screw, and a physical foaming agent is supplied into the cylinder at a portion downstream of the anti counterflow portion of the screw.

2. A molding method of a fiber filler reinforced resin molded article of claim 1, wherein the physical foaming agent is a super critical fluid.

3. A molding method of a fiber filler reinforced resin molded article of claim 1, wherein the reinforcement fiber is mixed with the resin in the cylinder at a portion that is located downstream of said supply portion of the physical foaming agent.

4. A molding method of a fiber filler reinforced resin molded article of claim 1, wherein the reinforcement fiber is provided independently so as to be mixed with the resin.

5. A molding method of a fiber filler reinforced resin molded article of claim 4, wherein the reinforcement fiber is provided in a form of a continuous fiber to the cylinder, and the provided continuous fiber is cut into pieces by the screw, whereby the reinforcement fiber is mixed with the resin in the cylinder.

6. A molding method of a fiber filler reinforced resin molded article of claim 1, wherein mixing and dispersion of the reinforcement fiber in the resin is promoted in a resin flow path from the supply portion of the physical foaming agent to the cavity of the mold.

7. A molding method of a fiber filler reinforced resin molded article of claim 1, wherein the resin with the physical foaming agent supplied thereto and the reinforcement fiber mixed therewith is collected temporarily, transmitted to an injection unit, metered for molding, and then supplied to the cavity of the mold via the injection unit.

8. A molding apparatus of a fiber filler reinforced resin molded article, in which a reinforcement fiber and a resin are plasticized and kneaded in a material supply cylinder including a screw with an anti counterflow portion, and the plasticized resin with the reinforcement fiber mixed therewith is injected into a cavity of a mold, the molding apparatus comprising:
a reinforcement-fiber mixing portion where the reinforcement fiber is mixed with the resin in the cylinder, the mixing portion being downstream of the anti counterflow portion of the screw; and
a foaming-agent supply portion where a physical foaming agent is supplied into the cylinder, the supply portion being downstream of the anti counterflow portion of the screw.

9. A molding apparatus of a fiber filler reinforced resin molded article of claim 8, wherein the physical foaming agent is a super critical fluid.

10. A molding apparatus of a fiber filler reinforced resin molded article of claim 8, wherein the reinforcement fiber is mixed with the resin in the cylinder at a portion that is located downstream of said supply portion of the physical foaming agent.

11. A molding apparatus of a fiber filler reinforced resin molded article of claim 8, wherein the reinforcement fiber is provided independently so as to be mixed with the resin.

12. A molding apparatus of a fiber filler reinforced resin molded article of claim 11, wherein the reinforcement fiber is provided in a form of a continuous fiber to the cylinder, and the provided continuous fiber is cut into pieces by the screw, whereby the reinforcement fiber is mixed with the resin in the cylinder.

13. A molding apparatus of a fiber filler reinforced resin molded article of claim 8, wherein there is provided a mixing-dispersion promoting device to promote mixing and dispersion of the reinforcement fiber in the resin in a resin flow path from the supply portion of the physical foaming agent to the cavity of the mold.

14. A molding apparatus of a fiber filler reinforced resin molded article of claim 8, wherein the resin with the physical foaming agent supplied thereto and the reinforcement fiber mixed therewith is collected temporarily, transmitted to an injection unit, metered for molding, and then supplied to the cavity of the mold via the injection unit.

15. A molding apparatus of a fiber filler reinforced resin molded article of claim 8, wherein there is provided a seal device to seal an inside from an outside of the cylinder at the reinforcement-fiber mixing portion.

16. A molding apparatus of a fiber filler reinforced resin molded article of claim 8, wherein there is provided a flow-amount detecting device that is provided in a leakage path of the physical foaming agent leaking from the reinforcement-fiber mixing portion and detects an amount of leakage of the physical foaming agent, and the physical foaming agent is configured to be supplemented from the foaming-agent supply portion according to the leakage amount thereof detected by the flow-amount detecting device.
